(19) United States
(12) Patent Application Publication
(10) Pub. No.: US 2026/0062067 A1
(43) Pub. Date: Mar. 5, 2026

(54) PICKUP TRUCK BED COVER

(71) Applicant: William R. Hamma, Rockfall, CT (US)

(72) Inventor: William R. Hamma, Rockfall, CT (US)

(21) Appl. No.: 18/822,204

(22) Filed: Sep. 1, 2024

(51) Int. Cl. B62D 33/027; B62D 33/04

(52) U.S. Cl. CPC B62D 33/027; B62D 33/046

(57) ABSTRACT

A cover that includes 1st and 2nd elongated bases respectively extending along the respective tops of 1st and 2nd truck sidewalls and engaging stake holes therein. 1st and 2nd hinges respectively secured to respective 1st and 2^{nd} bases carry 1st and 2nd rectangular imperforate elongated panels. Each of the imperforate elongated panels may have two hinge-connected planar sections.

### TECHNICAL FIELD

Pickup bed covers are protective covers that are installed over the bed of a pickup truck. The term pickup truck will be understood to refer to type of small truck with a separate open box cargo area that is used to carry things. More specifically such trucks have a back end made up of a cargo bed that is enclosed by 3 low walls with no roof above the cargo bed. The prior art covers come in a variety of styles, including folding, roll-up, retractable, and one-piece. They offer protection from the elements, such as rain, snow, and sun, and can also help to deter theft.

### BACKGROUND OF THE INVENTION

The prior art includes folding covers having multiple panels that fold back to open and provide access to the bed of the truck, roll-up covers that roll up towards the cab of the truck, retractable covers that slide open and closed along rails mounted to the sides of the truck bed, one-piece covers that are a solid one-piece construction that lifts open from the back of the truck bed; hinged covers with single or multiple hinge points that allow them to be lifted up like a trunk lid and soft covers that are usually made of vinyl or canvas material.

### PRIOR ART

The prior art in many cases fails to adequately secure valuable goods that may be transported by truck. Furthermore, the prior art often merely provides a cover extending intermediate the side rails of the truck bed. Such covers may be sufficient if the goods being carried cannot merely tolerate moisture. In the event the goods are cumbersome and do not fit in the space intermediate between the truck bed and the top of the side rails, many covers not only do not assist in carrying such cumbersome loads, may impede carrying cumbersome loads. For example, cumbersome loads that extend above the side rails of the truck, that extend along the left and right sides of the truck, will prevent the use of common covers. Particularly if the cover relies on gravity to properly seat the cover on tops of the side rails and the load extends to a higher elevation than the tops of the side rails, such prior art structures will be defeated by cumbersome loads.

### SUMMARY OF THE INVENTION

The shortcomings of the prior art are overcome and additional advantages are provided in a cover for placement over the bed of a truck having a generally planar rectangular bed section located to the rear of a cab section and having 1st and 2nd elongated upwardly extending sidewalls bounding elongated sides of the bed, an upwardly extending front wall bounding the front of the bed and having stake holes located proximate to the axial extremities of each side wall which includes 1st and 2nd elongated bases respectively extending along the respective tops of said 1st and 2nd sidewalls and engaging stake holes therein.

In some embodiments 1st and 2nd hinges respectively secure respective 1st and 2nd bases and 1st and 2nd rectangular imperforate elongated panels secured to respective 1st and 2nd whereby said 1st and 2nd rectangular imperforate panels may be moved to a horizontal position above the bed of the truck or to a vertical position extending above the side rails.

In some embodiments the 1st and 2nd rectangular imperforate elongated panels include inboard and outboard imperforate elongated panels joined by a hinge whereby the inboard and outboard imperforate elongated panels are capable of being moved from a 1st position wherein said inboard and outboard imperforate elongated panels are coplanar to a 2nd position wherein said inboard and outboard imperforate elongated panels are disposed in side-to-side abutting relationship.

In some embodiments the inboard and outboard imperforate elongated panels that are substantially the same size.

The cover may have inboard and outboard imperforate elongated panels that are collectively dimensioned and configured so that when disposed in a coplanar relationship, the collective extent of the combined inboard and outboard panels cover the entire bed of the truck

Additional features and advantages are realized through the techniques of the present invention. Other embodiments and aspects of the invention are described in detail herein and are considered a part of the claimed invention.

### BRIEF DESCRIPTION OF DRAWINGS

The subject matter which is regarded as the invention is particularly pointed out and distinctly claimed in the concluding portion of the specification. Although specific features of various exemplary embodiments of the invention may be shown in some drawings and not in others, this is for convenience only. In accordance with the principles of the invention, any feature of a drawing maybe referenced and/or claimed in combination with any feature of any other drawing.

The invention, however, both as to organization and method of practice, together with the further objects and advantages thereof, may best be understood by reference to the following description taken in connection with the accompanying drawings in which:

FIG. 1 is a rear view of a pickup truck having a cover in accordance with one form of the present invention deployed to fully cover the bed of the pickup truck, the view illustrates two outboard panels that are each connected by a hinge to respective bases attached to the side rails of the pickup truck. Each outboard panel is respectfully connected by a hinge to an inboard panel. The inboard edges of each inboard panel abut in the deployed illustrated position (for simplicity the front panel is not illustrated in this view),

FIG. 2 is a side view of a cam used to secure each of the two bases 20 of the cover 14 that are respectively mounted on the pickup truck bed side rails that are disposed in mutually parallel relationship and extend fore and aft on each side of the truck's bed,

FIG. 3 is a side view of the engagement between the front panel 30 disposed in substantially parallel relationship to the back window of the pickup truck and one of the outboard panels 18,

FIG. 4 is a view taken from a vantage point behind the left side driver's seat and facing the rear of the truck illustrating a base 18 installed on the side rail of the pickup truck (not shown) as well as the hinged connection 20 between the base 18 and an outboard panel 16. The outboard panel 16 is connected by another hinge 34 to the folded inboard panel 24. In this position the apparatus better secures loads that are higher than the side rails of the pickup.

FIG. 5 is another view of the interface between the front panel and an outboard panel,

FIG. 6 is another side view of the engagement between the front panel disposed in substantially parallel relationship to the back window of the pickup truck and one of the outboard panels,

FIG. 7 is still another view of the engagement between the front panel disposed in a substantially parallel relationship to the back window of the pickup truck and one of the outboard panels,

FIG. 8 is a fragmentary view of the front panel extending generally parallel to the cab rear window engaged with first and second outboard panels that are respectively hinged to first and second inboard panels,

### DETAILED DESCRIPTION OF THE INVENTION

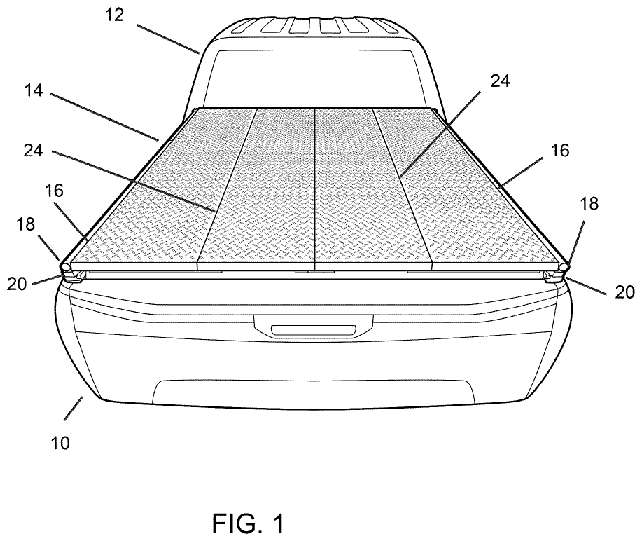

FIG. 1 is a rear view of a pickup truck 10 having a cab of the city of all the regular summer base 18 basis and a cover 14 in accordance with one form of the present invention deployed to fully cover the bed (not visible) of the pickup truck 10. The view illustrates two outboard panels 16 that are each connected by a hinge 18 to respective bases 20 attached to the side rails of the pickup truck. More specifically, each base 20 is an elongated member having depending fingers (not shown)engaging front and rear stake holes. The stake holes are located on each side rail disposed on the left and right sides of the truck 10. Each outboard panel 16 is respectfully connected by a hinge to an inboard panel 24. The inboard edges of each inboard panel 24 abut along a virtual plane that bisects both the cover 14 as well as the truck bed in the deployed illustrated position. For simplicity, the front panel 30 is not illustrated in this view.

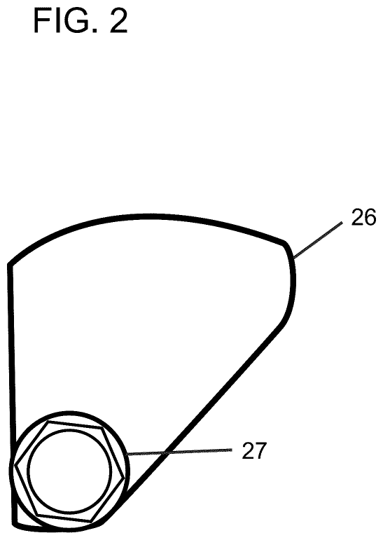

FIG. 2 is a side view of a cam 26. At least one such cam 26 engages each base 20 to secure each of the two bases 20. Those skilled in the art will recognize that the cam 26 is carried by a bolt 27. As the cam is rotated locking engagement is achieved with the truck side rail. The bolt 27 ensures the engagement will not change. More specifically, each base 20 is respectively mounted on the pickup truck bed side rails that are disposed in mutually parallel relationship and extend fore and aft on each side of the truck's bed. The cam 26 ensures positive engagement between each base and the respective front and rear stake holes disposed at the corners of the truck bed.

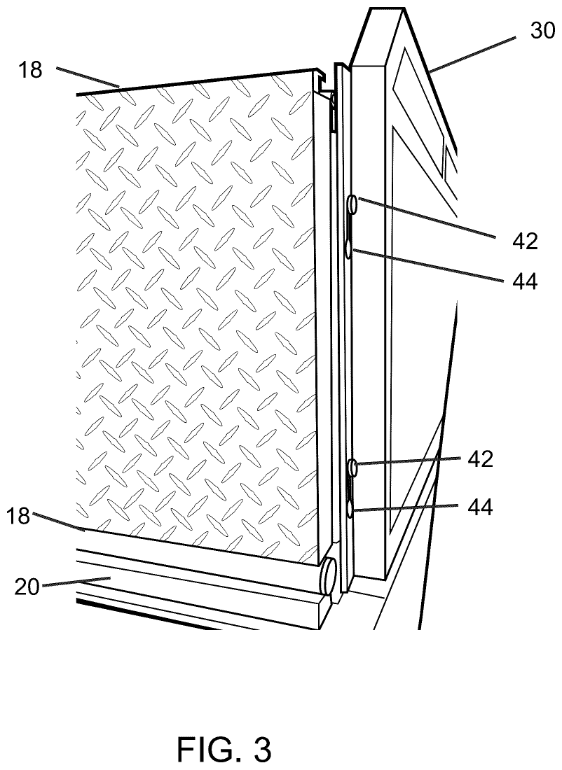

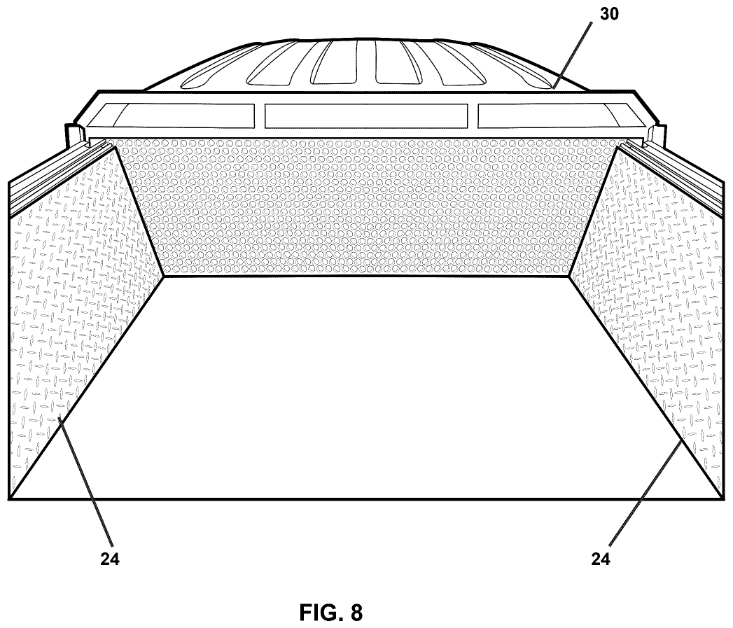

In addition to the outboard panels 16 and the inboard panels 24 embodiments of the present invention include a front panel 30 that extends in parallel spaced relationship to the back window of the truck as best seen in FIG. 8. That front panel 30 is also shown in FIGS. 3, 5, 6 and 7. The front panel 30 includes a plurality of closely spaced holes that protect the rear window of the cab of the truck, while still allowing the driver to observe the load as well as following vehicles.

In contrast, the inboard panels 24 and the outboard panels 18 are intended to keep the load area substantially dry. Accordingly, those panels are imperforate. In some embodiments, the inboard and outboard panels may be embossed. The embossing achieves both an aesthetic benefit and increases the strength of the metal sheet.

FIG. 3 is a side view of the engagement between the front panel 30 disposed in a substantially parallel relationship to the back window of the pickup truck and one of the outboard panels 16.

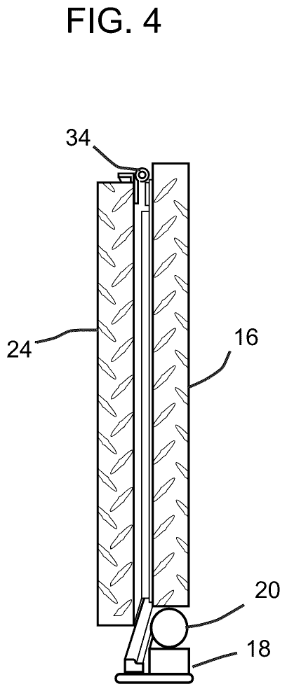

FIG. 4 is a view of the inboard and outboard panels taken from a vantage point behind the left side driver's seat and facing the rear of the truck that illustrates a base 18 installed on the side rail of the pickup truck (not shown) as well as the hinged connection 20 between the base 18 and an outboard panel 16 which is connected by another hinge 34 to the folded inboard panel 24. In this position, the apparatus better secures loads that are higher than the side rails of the pickup.

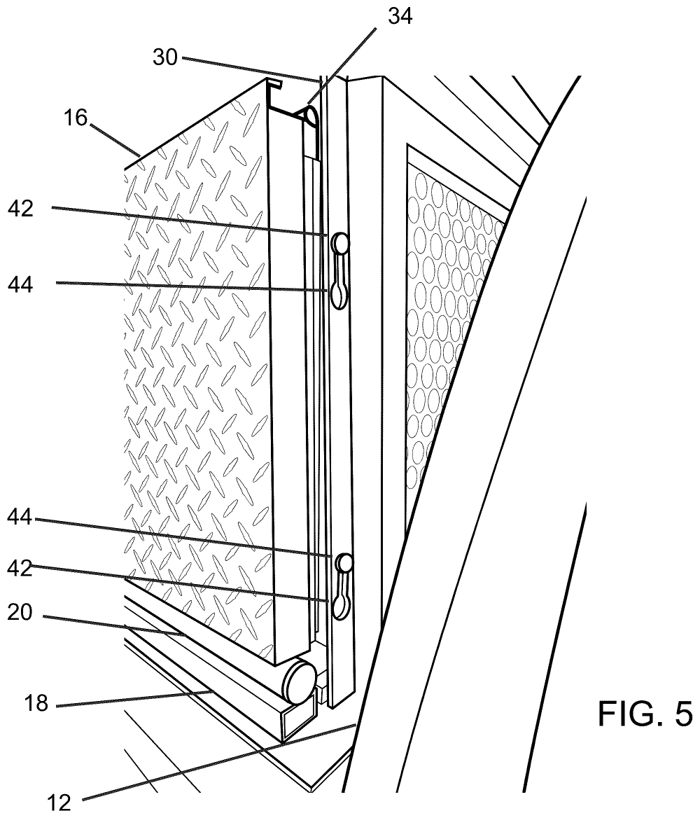

FIG. 5 is another view of the interface between the front panel 30 outboard and an outboard panel 16. More specifically, a side flange of the front panel 30 includes 1st and 2nd key hole slots 42 dimensioned and configured to engage 1st and 2nd round head posts 44 located on the side edge of the outboard panel 16. Thus, during installation the user will position each inboard panel 24 and each outboard panel 16 in vertical orientations with the panel 24 and panel perpendicular to each other. Thus the left inboard panel 24 and the left outboard panel 16 will be in side abutting relationship as well as the right inboard panel 24 and 8 right outboard panel 16 will also be in side abutting relationship. The front panel 30 is then positioned in perpendicular relation to the inboard panel 16 with the 1st and 2nd key hole slots 44 in registered relationship with the respective 1st and 2nd round head posts 42. Meshing engagement between the posts 42 and the keyhole slots 44 results in positive engagement resulting in a structure that firmly connects the respective parts thereof.

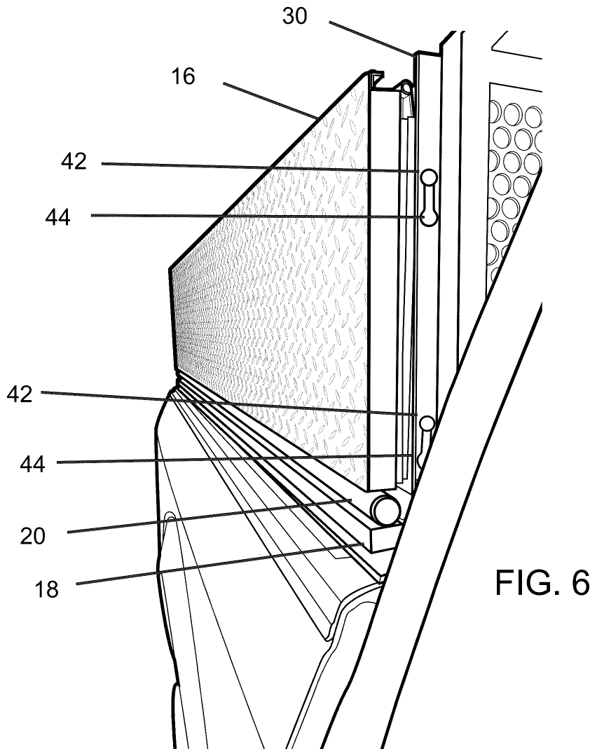

FIG. 6 is another side view of the engagement between the front panel 30 disposed in a substantially parallel relationship to the back window of the pickup truck and the right outboard panel 16.

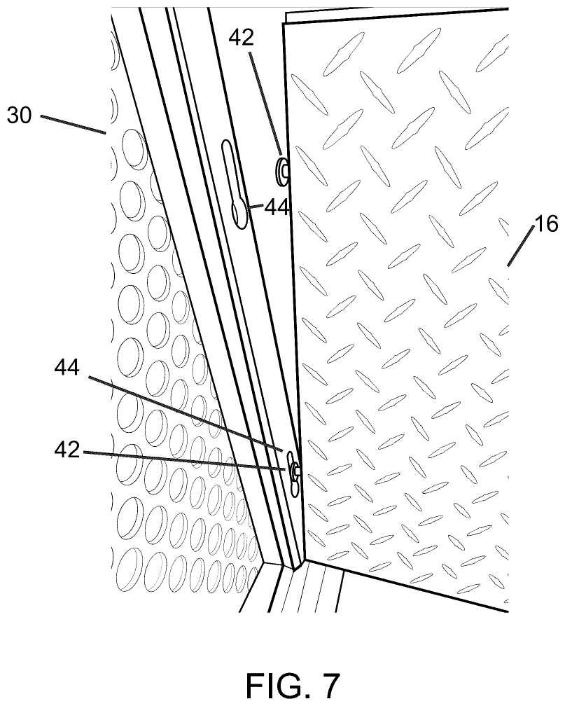

FIG. 7 is still another view of the engagement between the posts 42 of the right front panel 16 engaging the keyhole slots 44 in the front panel 30 disposed in substantially parallel relationship to the back window of the pickup truck.

FIG. 8 is a view of the front panel 30 extending generally parallel to the cab rear window engaged with first and second outboard panels 16 (not clearly visible) that are respectively hinged to first and second inboard panels 24.

All publications and patent applications mentioned in this specification are indicative of the level of skill of those skilled in the art to which this invention pertains. All publications and patent applications are herein incorporated by reference to the same extent as if each individual publication or patent application was specifically and individually indicated to be incorporated by reference.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “an imager” should typically be interpreted to mean “at least one imager”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two images,” or “a plurality of images,” without other modifiers, typically means at least two images). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Although the description above contains many specifics, these should not be construed as limiting the scope of the invention, but as merely providing illustrations of some of the presently preferred embodiments of this invention. Thus, the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

1. A cover for placement over the bed of a truck having a generally planar rectangular bed section located to the rear of a cab section and having 1st and 2nd elongated upwardly extending sidewalls bounding elongated sides of the bed, an upwardly extending front wall bounding the front of the bed and having stake holes located proximate to the axial extremities of each side wall which comprises:
1st and 2nd elongated bases respectively extending along the respective tops of said 1st and 2nd sidewalls and engaging stake holes therein;
1st and 2nd hinges respectively secured to respective 1st and 2^{nd} bases;
1st and 2nd rectangular imperforate elongated panels secured to respective 1st and 2^{nd} hinges;
whereby said 1st and 2nd rectangular imperforate panels may be moved to a horizontal position above the bed of the truck or to a vertical position extending above the side rails.

2. The cover as described in claim 1 wherein each of said 1st and 2nd rectangular imperforate elongated panels includes inboard and outboard imperforate elongated panels joined by a hinge whereby the inboard and outboard imperforate elongated panels are capable of being moved from a 1st position wherein said inboard and outboard imperforate elongated panels are coplanar to a 2nd position wherein said inboard and outboard imperforate elongated panels are disposed in side to side abutting relationship.

3. The cover as described in claim 2 wherein each of said inboard and outboard imperforate elongated panels are substantially the same size.

4. The cover as described in claim 3 wherein said inboard and outboard imperforate elongated panels are collectively dimensioned and configured so that when disposed in coplanar relationship, the collective extent of the combined inboard and outboard panels cover the entire bed of the truck.

5. The cover as described in claim 4 further including a front panel disposed in substantially parallel relationship to the back of the cab of the truck.

6. The cover as described in claim 4 wherein said front panel includes at least one key hole slot in the flange on each side thereof dimensioned and configured for receiving at least one post carry-on an outboard panel whereby the front panel will hold each outboard panel in a vertical position whereby the truck is better able to carry cumbersome cargo.
